(19) United States
(12) Patent Application Publication
(10) Pub. No.: US 2014/0160749 A1
(43) Pub. Date: Jun. 12, 2014

(54) LIGHTING DEVICE AND SURFACE ILLUMINATION APPARATUS

(71) Applicant: SAMSUNG ELECTRONICS CO., LTD., Suwon-si (KR)

(72) Inventors: Ki Un LEE, Hwaseong-si (KR); June JANG, Seoul (KR); Seung Gyun JUNG, Suwon-si (KR)

(73) Assignee: SAMSUNG ELECTRONICS CO., LTD., Suwon-si (KR)

(21) Appl. No.: 14/067,798

(22) Filed: Oct. 30, 2013

(30) Foreign Application Priority Data
Dec. 11, 2012 (KR) 10-2012-0143955

(51) Int. Cl. F21K 99/00

(52) U.S. Cl. CPC F21K 9/30
USPC 362/235

(57) ABSTRACT

A lighting device includes a light emitting module and a diffusion plate. The light emitting module includes a light source substrate including a spine part and at least one branch part, and a plurality of light sources disposed on the light source substrate and arranged in a repeated diamond shape pattern. The diffusion plate is disposed in a path of light emitted by the light sources. A length ratio of two intersecting diagonals of each diamond in the diamond shape pattern is at least 1:1 and no more than 1:1.5. A distance h between the light sources and the diffusion plate satisfies the expression 0.8≦−0.0592MH⁴+0.4979MH³−1.5269MH²+1.9902MH−0.0888, where MH is a ratio of the distance h to the greater of two diagonal lengths of diamonds in the diamond shape pattern.

### CROSS-REFERENCE TO RELATED APPLICATION

This application claims priority to, and the benefit of, Korean Patent Application No. 10-2012-0143955 filed on Dec. 11, 2012, with the Korean Intellectual Property Office, the disclosure of which is incorporated herein by reference.

### TECHNICAL FIELD

The present disclosure relates to a light emitting module and a surface illumination apparatus including the same.

### BACKGROUND

In recent years, semiconductor light emitting devices have been used in backlight units provided in display devices such as television screens and computer monitors, or as light sources utilized in illumination devices such as ceiling-mounted lamps and the like. As advances in semiconductor light emitting devices have increased component efficiency, and as pressure to reduce manufacturing costs remains high, illumination apparatuses are being developed that produce the same light output but include fewer semiconductor light emitting devices. However, because semiconductor light emitting devices produce a highly directional light, the uniformity of light produced by the illumination apparatuses may be deteriorated as the number of semiconductor light emitting devices is reduced and spacing between semiconductor light emitting devices consequently increases. Additionally, the need for the semiconductor light emitting devices to be spaced apart to provide uniform light makes it difficult to significantly reduce the area of substrate on which the light emitting devise are disposed, and to thereby reduce material costs for producing the illumination apparatuses. Accordingly, a novel scheme to decrease the manufacturing costs of a light emitting module, while not affecting light properties of the light emitting module, is needed.

### SUMMARY

An aspect of the disclosure provides a light emitting module having improved light uniformity through a design and a layout of a light source substrate and light sources.

Another aspect of the disclosure provides a surface illumination apparatus including a light emitting module as described above.

According to an aspect of the present disclosure, there is provided a lighting device including a light emitting module and a diffusion plate. The light emitting module includes: a light source substrate including a spine part and at least one branch part extending from a side surface of the spine part; and a plurality of light sources disposed on the light source substrate and arranged in a repeated diamond shape pattern in which a light source is disposed at each vertex of each diamond and no light source is disposed in an interior of a diamond. The diffusion plate is disposed in a path of light emitted from the plurality of light sources. A length ratio of two intersecting diagonals of each diamond in the diamond shape pattern is at least 1:1 and no more than 1:1.5, and a distance h between the plurality of light sources and the diffusion plate satisfies the following numerical expression:

$$.8 \leq - 0.0592 M {H}^{4} + 0.4979 M {H}^{3} - 1.5269 M {H}^{2} + 1.9902 M H - 0.0888 , \\ where$$

$$M H = \frac{\begin{matrix}Distance ( h ) between the plurality of \\ light sources and the diffusion plate\end{matrix}}{\begin{matrix}Greater length among lengths of two intersecting \\ diagonals ( x , y ) of diamond shape pattern\end{matrix}} .$$

The MH value may satisfy the condition of 0.01≦MH≦3.

The plurality of light sources arranged in the repeated diamond shape pattern can be disposed in a plurality of columns, and a difference between a number of light sources disposed in a left-most column of the plurality of columns and a number of light sources disposed in a right-most column of the plurality of columns may be 1.

The spine part may be rectangular.

The light source substrate may comprise a plurality of branch parts and the plurality of light sources may be mounted on the plurality of branch parts.

The light source substrate may comprise a plurality of branch parts and at least one of the plurality of branch parts may extend from one side surface of the spine part and at least another of the plurality of branch parts may extend from another side surface of the spine part opposite to the one side surface.

The branch part may further include at least one sub-branch portion extending from a side surface of the branch part.

The light emitting module may further include a hook part disposed on one side portion of the light source substrate.

The light emitting module may further include a through-hole for screw fastening, disposed on the light source substrate.

The light emitting module may further include a connector part disposed on the light source substrate, and the connector part may include both of a poke-in type connector and a push-in type connector.

The light source substrate may be a printed circuit board (PCB) having a circuit pattern disposed thereon.

According to an aspect of the present disclosure, there is provided a surface illumination apparatus including: a base part; a light emitting module mounted on the base part, the light emitting module including: a light source substrate including a spine part and at least one branch part extending from a side surface of the spine part; and a plurality of light sources disposed on the light source substrate and arranged in a repeated diamond shape pattern in which a light source is disposed at each vertex of each diamond and no light source is disposed in an interior of a diamond; and a diffusion plate disposed in a path of light emitted from the plurality of light sources, wherein a ratio of lengths of two intersecting diagonals of each diamond in the diamond shape pattern is at least 1:1 and no more than 1:1.5, and a distance h between the plurality of light sources and the diffusion plate satisfies the following numerical expression:

$$0.8 \leq - 0.0592 M {H}^{4} + 0.4979 M {H}^{3} - 1.5269 M {H}^{2} + 1.9902 M H - 0.0888 , \\ where$$

$$M H = \frac{\begin{matrix}Distance ( h ) between the plurality of \\ light sources and the diffusion plate\end{matrix}}{\begin{matrix}Greater length among lengths of two intersecting \\ diagonals ( x , y ) of diamond shape pattern\end{matrix}} .$$

The base part may further include a fixing bar covering a portion of the branch part and fixing the light emitting module to the base part.

The light source substrate may further include a hook part disposed on one side thereof, and the light emitting module may be fastened to the base part by the hook part and a hook formed on the base part.

The light source substrate may comprise a plurality of light source substrates having the plurality of light sources disposed thereon, and the plurality of light source substrates are disposed on the base part to be adjacent to one another such that light sources disposed on different light source substrates that are adjacent to one another may be disposed so as to be arranged according to the repeated diamond shape pattern and to satisfy the ratio of lengths of two intersecting diagonals of each diamond in the diamond shape pattern and to satisfy the numerical expression for the distance h between the plurality of light sources and the diffusion plate.

According to another aspect of the present disclosure, a lighting device may include: a light emitting module having a light source substrate including a spine part and at least one branch part extending from a side surface of the spine part, and a plurality of light sources disposed on the light source substrate and arranged in a repeated diamond shape pattern in which a light source is disposed at each vertex of each diamond and no light source is disposed in an interior of a diamond; and a diffusion plate disposed in a path of light emitted from the plurality of light sources, wherein a distance h between the plurality of light sources and the diffusion plate satisfies the following numerical expression: 1≦MH≦3, where MH is a ratio of the distance h to the greater of two diagonal lengths of diamonds in the diamond shape pattern.

A ratio of lengths of the two diagonals of each diamond in the diamond shape pattern may be at least 1:1 and no more than 1:1.5.

The light source substrate may comprise first and second separated light source substrates having interlocking shapes, such that the first and second separated light source substrates jointly form a substantially rectangular substrate when positioned so as to be interlocked.

The light source substrate may comprise a plurality of branch parts extending from a side surface of the spine part, and a width of each branch part may be substantially equal to a spacing between adjacent branch parts extending from the side surface of the spine part.

### BRIEF DESCRIPTION OF THE DRAWINGS

The above and other aspects, features, and other advantages will be more clearly understood from the following detailed description taken in conjunction with the accompanying drawings, in which:

FIG. 1 illustrates a lighting device including a light emitting module according to an embodiment;

FIGS. 2 to 4 are plan views of light emitting modules according to other embodiments;

FIG. 5 is a graph illustrating a relationship between a length ratio of two intersecting diagonal lines of a diamond shape and a degree of light uniformity;

FIG. 6 is a graph illustrating a relationship between light uniformity with regard to a ratio MH of a length from a light source module to a diffusion plate, and the greater of two diagonal line lengths in a diamond shape pattern;

FIGS. 7A and 7B illustrate fastening-type hook parts according to an embodiment;

FIGS. 8A and 8B illustrate connector parts according to an embodiment;

FIG. 9 is a cross-sectional view of a surface illumination apparatus according to an embodiment;

FIG. 10 is a perspective view of the surface illumination apparatus illustrating a fastening structure thereof according to another embodiment; and

FIG. 11 is a plan view of a surface illumination apparatus according to another embodiment.

### DETAILED DESCRIPTION OF EMBODIMENTS

Embodiments will now be described in detail with reference to the accompanying drawings.

Embodiments may, however, be embodied in many different forms and should not be construed as being limited to embodiments set forth herein. Rather, these embodiments are provided so that this disclosure will be thorough and complete, and will fully convey the scope of the inventive concepts to those skilled in the art.

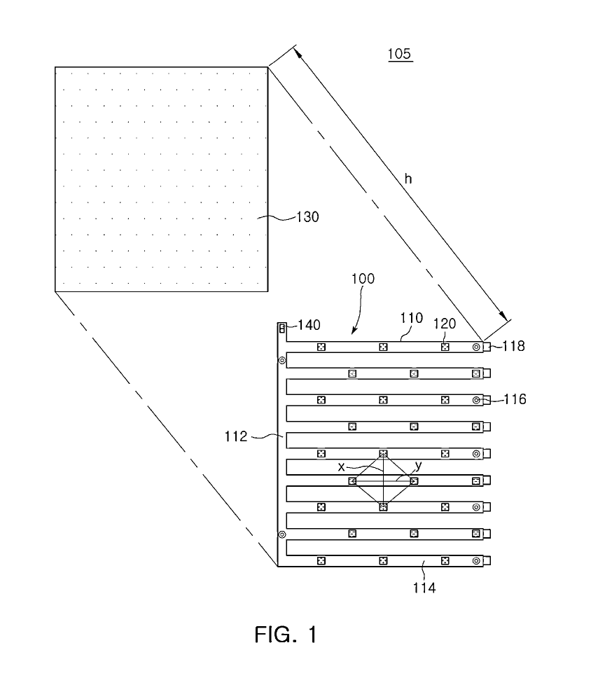

FIG. 1 illustrates a lighting device 105 including a light emitting module 100 according to an embodiment of the inventive concepts.

With reference to FIG. 1, a light emitting module 100 according to an embodiment may include a light source substrate 110, and a plurality of light sources 120 disposed on the light source substrate 110. The lighting device may include the light emitting module 100 and a diffusion plate 130.

The light source substrate 110 may be a circuit board commonly used in the art, for example, a printed circuit board (PCB), a metal core printed circuit board (MCPCB), a metal printed circuit board (MPCB), a flexible printed circuit board (FPCB), or the like. The light source substrate 110 may include a wiring pattern provided on a surface thereof, in an inner portion thereof, and the like. The wiring pattern may be electrically connected to the plurality of light sources 120, and serve to interconnect the plurality of light sources 120 and at least one connector part 140.

Here, the light source substrate 110 can have a substantially quadrilateral outer perimeter with one or more gaps (e.g., rectangular gaps) formed therein, as shown in FIG. 1. In particular, the light source substrate 110 may include a spine part 112, and at least one branch part 114 extending from a side surface of the spine part 112. The spine part 112 may be rectangular, and the branch part 114 may be rectangular and may be understood to be a portion extending from a side of the spine part 112, but this should not be considered to be limiting.

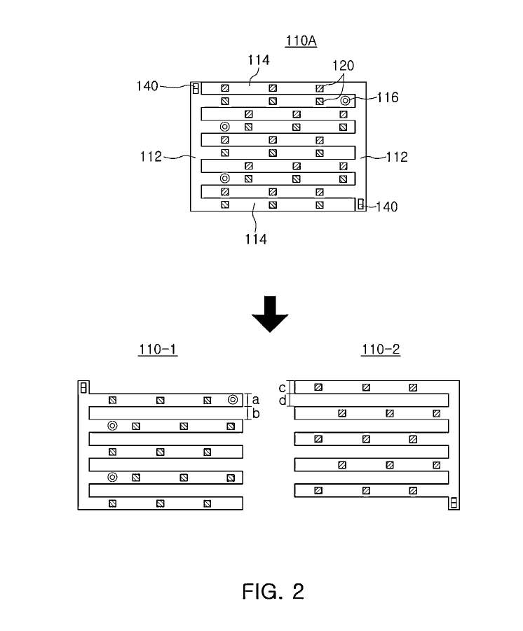

As such, the light source substrate 110 including the spine part 112 and the branch part 114 may have various shapes. The light source substrate 110 may be obtained in such a manner that multiple light source substrates 110 are separated from a single mother substrate, such that each light source substrate 110 can be provided in a respective lighting device. This will be described in more detail through various examples with reference to FIGS. 2 to 4.

FIGS. 2 to 4 are plan views showing various shapes of light source substrates 110 according to different embodiments in more detail.

As shown in FIG. 2, a substantially rectangular mother substrate 110A may be separated with a single cut to thus provide two separated light source substrates 110-1 and 110-2. In addition, in order to secure homogeneous properties in the separated light source substrates 110-1 and 110-2, the cutting may be performed such that the branch parts 114 of two light source substrates 110-1 and 110-2 have substantially identical respective widths a and c, but this should not be considered to be limiting. In this case, it can be considered that, based on a light source substrate 110A, respective intervals b and d, between the branch parts 114 having respective widths a and c and branch parts 114 adjacent thereto, are substantially the same as each other.

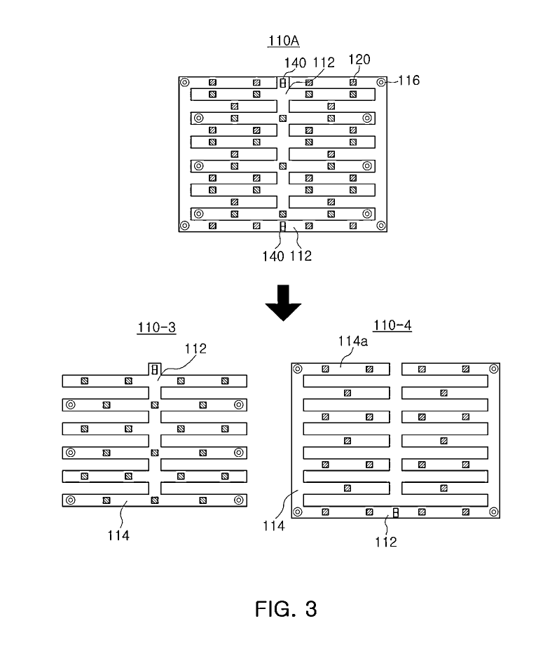

In addition, as shown in FIG. 3, alight source substrate 110 according to another embodiment may include two light source substrates 110-3 and 110-4 cut from a single mother substrate 110A. Therefore, a separated light source substrate 110-3, of the two separated light source substrates, may include a plurality of branch parts 114. In this case, the plurality of branch parts 114 may be branch parts extending from one side surface of a spine part 112 and branch parts extending from another side surface of the spine part 112 opposite to the one side surface.

Further, the separated light source substrate 110-4 may include a plurality of branch parts 114 (e.g., two branch parts 114 as shown in FIG. 3). Here, each of the plurality of branch parts 114 may include a plurality of sub-branch portions 114a extending from a side surface of the respective branch part 114.

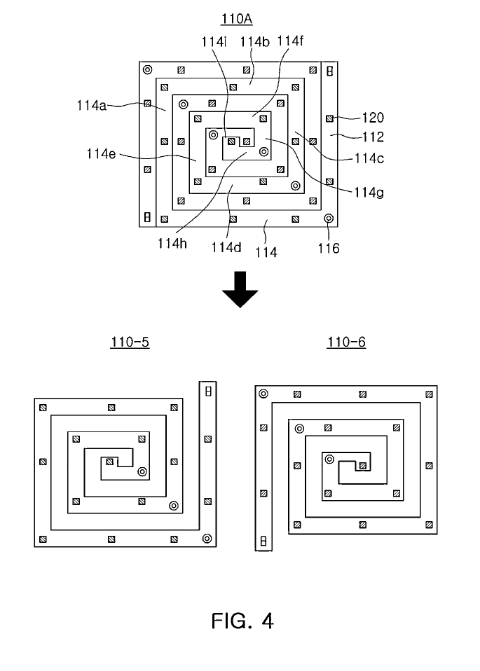

Alternatively, as shown in FIG. 4, the light source substrate 110 may include light source substrates 110-5 and 110-6 cut from a single mother substrate 110A. The light source substrates 110-5 and 110-6 may respectively include a spine part 112, a branch part 114 extending from a side surface of the spine part 112, and a sub-branch portion 114a extending from a side surface of the branch part 114. The light source substrates 110-5 and 110-6 may further include a second sub-branch portion 114b extending from a side surface of the sub-branch portion 114a. More specifically, each respective light source substrate 110 may include a spine part 112 and a branch part 114, and second to tenth sub-branch portions 114b to 114i, but this should not be considered to be limiting. Thus, the number of spine part(s) 112, branch part(s) 114, and sub-branch portion(s) 114a included in the light source substrate 110 may be appropriately altered, according to respective embodiments.

As such, the light source substrate 110 according to embodiments of the present inventive concepts may have improved use efficiency in which a necessary substrate area is reduced to approximately half that of an equivalent rectangular light source substrate. The light source substrate 110 can be provided by cutting a single mother substrate 110A into two light source substrates 110.

In the above-mentioned examples of substrates, a substrate is described as being manufactured by cutting a mother substrate for ease of explanation. However, a substrate may also be directly manufactured as a substrate having one of the shapes or forms described above, without necessarily requiring a cutting process.

Hereinafter, a plurality of light sources 120 according to various embodiments will be described in more detail.

Referring back to FIG. 1, a light emitting module 100 according to an embodiment may include a plurality of light sources 120 disposed on the light source substrate 110.

The plurality of light sources 120 may be any devices that emit light. For example, the light sources 120 may be light emitting device packages including a semiconductor light emitting device, and/or may be semiconductor light emitting devices directly mounted on the light source substrate 110. Each of plurality of light sources 120 may emit light having a same predetermined wavelength. Alternatively, different light sources 120 of the plurality of light sources may generate different colors of light. The light sources 120 may include a wavelength conversion material such as a phosphor in order to emit white light, but should not be construed as being limited thereto.

The plurality of light sources 120 may only be mounted on the branch parts 114 in the light source substrate 110, such that no light source 120 is mounted on the spine part 112, but this is not limiting. That is, one or more of the plurality of light sources 120 may be mounted on the spine part 112, and the numbers of light sources 120 mounted on the branch part 114 and on the spine part 112 may be appropriately varied as needed. In a case in which a plurality of branch parts 114 are present, light sources 120 may not be mounted on one or more of the branch parts among the plurality of branch parts 114.

The light sources 120 may be disposed according to a regular repeated pattern, for example in the form of a diamond having four vertices. In a repeated diamond-shape pattern, a light source 120 may be positioned at each vertex position of the diamond-shape pattern, and the light sources 120 may be disposed such that no light source 120 is disposed in an interior of each diamond of the pattern. In detail, the plurality of light sources 120 may be arrayed according to a first matrix pattern in which the plurality of light sources 120 are arrayed in rows and columns, and a second matrix pattern in which the plurality of light sources 120 are arrayed in rows and columns, and such that the first and second matrix patterns are offset from each other such that a single light source 120 of the second matrix pattern is positioned on the inside of a quadrangular shape formed by four light emitting devices of the first matrix matter that are adjacent to one another. To more clearly illustrate the description, the light sources 120 arrayed in the first matrix and the second matrix are shown in FIG. 1 and are respectively represented by ‘+’ and ‘−’ identifiers in the figure.

A matrix pattern configured of rows and columns and having light sources 120 arrayed as described above may be defined as a matrix M. In the matrix M, a position in which a light source 120 is disposed is indicated as 1, while a position in which no light source 120 is disposed is indicated as 0. The matrix M may be represented as follows:

$$M = ( \begin{matrix}1 & 0 & 1 & 0 & 1 & 0 \\ 0 & 1 & 0 & 1 & 0 & 1 \\ 1 & 0 & 1 & 0 & 1 & 0 \\ 0 & 1 & 0 & 1 & 0 & 1 \\ 1 & 0 & 1 & 0 & 1 & 0 \\ 0 & 1 & 0 & 1 & 0 & 1 \\ 1 & 0 & 1 & 0 & 1 & 0 \\ 0 & 1 & 0 & 1 & 0 & 1 \\ 1 & 0 & 1 & 0 & 1 & 0\end{matrix} )$$

According to an embodiment of the present inventive concepts, the number of disposed light sources 120 may be reduced to approximately half that of the following matrix prior_M in which light sources are arrayed in a single matrix configured of a plurality of rows and columns. In addition, according to an embodiment of the present inventive concepts, because the light sources 120 are disposed to be offset from one another, light uniformity is not degraded despite the reduction in the number of light sources 120.

$$prior\_M = ( \begin{matrix}1 & 1 & 1 & 1 & 1 & 1 \\ 1 & 1 & 1 & 1 & 1 & 1 \\ 1 & 1 & 1 & 1 & 1 & 1 \\ 1 & 1 & 1 & 1 & 1 & 1 \\ 1 & 1 & 1 & 1 & 1 & 1 \\ 1 & 1 & 1 & 1 & 1 & 1 \\ 1 & 1 & 1 & 1 & 1 & 1 \\ 1 & 1 & 1 & 1 & 1 & 1 \\ 1 & 1 & 1 & 1 & 1 & 1\end{matrix} )$$

In addition, as represented in the matrix M above, the array may be designed so that the number of light sources disposed in a first (left-most) column of the matrix M (five (5)) is different from the number of light sources disposed in a last (right-most) column of the matrix M (four (4)). In general, a difference in the number of the light sources disposed in the first and last columns as described above may be ‘1’. As such, in the case in which the numbers of light sources disposed in the first column and the last column are different, relatively suitable light uniformity may be easily provided when a plurality of the light source substrates 110 are disposed in a tile arrangement such that they are adjacent to each other. This will be described in detail below.

On the other hand, the plurality of light sources 120 according to an embodiment may be disposed on the light source substrate 110 including the spine parts 112 and the branch parts 114, i.e. on alight source substrate that is not a flat-type square or rectangular shaped substrate. Because of the shape of the light source substrate 110, it may be difficult to position the plurality of light sources 120 so as to be disposed in an optimum layout, such as in a repeated quadrilateral pattern (e.g., a repeated diamond shape pattern).

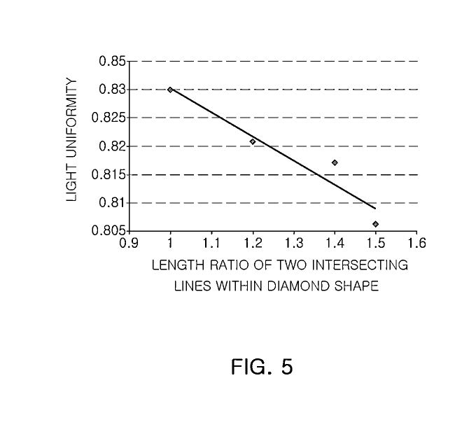

That is, as illustrated in an experimental data graph of FIG. 5, the plurality of light sources may be disposed in the arrayed diamond shape pattern as described above so as to satisfy a particular condition, such as a 1:1 length ratio between the lengths of the two diagonally-intersecting lines (x and y) of each diamond in the pattern. The 1:1 length ratio condition can provide a significantly enhanced light uniformity. However, it may be difficult to dispose the light sources 120 such that the diamond shape pattern satisfies the 1:1 condition of the length ratio, especially in situations in which the light sources 120 are disposed on a light source substrate 110 including the spine part 112 and the branch part 114. Thus, the plurality of light sources 120 may be disposed to satisfy an alleviated condition as described below. The alleviated condition may seek to simultaneously provide a high light uniformity while being suitable for use on the inter-digitated light source substrate 110.

In detail, the plurality of light sources 120 may be arrayed to satisfy a 1:1 to 1:1.5 ratio between the lengths of two intersection diagonals (x and y) of diamonds in the diamond shape pattern. This condition is a relaxed version of the 1:1 ratio of lengths which provides a relatively optimum light uniformity condition. In general, in order to maintain uniformity of light produced by the plurality of light sources 120, a diffusion plate 130 may be disposed so as to satisfy the following equation:

$$0.8 \leq - 0.0592 M {H}^{4} + 0.4979 M {H}^{3} - 1.5269 M {H}^{2} + 1.9902 M H - 0.0888 , \\ where$$

$$( M H = \frac{\begin{matrix}Distance ( h ) between the plurality of \\ light sources and the diffusion plate\end{matrix}}{\begin{matrix}Greater length among lengths of two intersecting \\ diagonals ( x , y ) of diamond shape pattern\end{matrix}} ,$$

wherein the numerator h and denominator max(x, y) have the same length unit applied thereto).

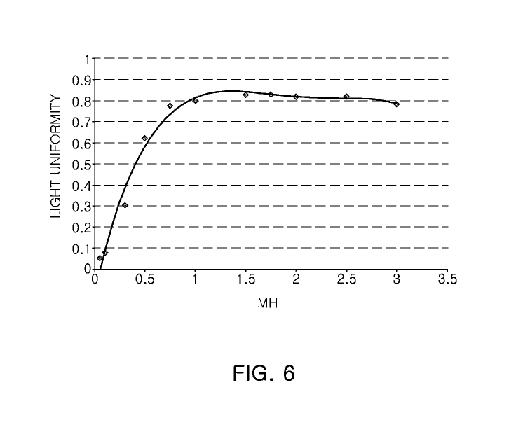

The equation above will be described in more detail with reference to FIG. 6.

FIG. 6 is a graph illustrating a relationship between MH and the uniformity of light emitted from the diffusion plate 130. MH is plotted along the x axis of the graph, and corresponds to a ratio of a distance h, from the plurality of light sources 120 to the diffusion plate 130, to a greater of two diagonal line lengths (x and y) in a diamond shape pattern according to which the light sources 120 are disposed. The graph of FIG. 6 shows light uniformity values obtained for each of a plurality of different values of MH. According to an empirical formula derived from the above-mentioned result graph, light uniformity has the following relational expression with regard to MH:

Light Uniformity=−0.0592MH⁴+0.4979MH³−1.5269MH²+1.9902MH−0.0888,

wherein the R squared, indicating the accuracy of the empirical formula, is 0.9873.

In general, the MH value is selected to be within the range 0.01≦MH≦3, which is provided by considering an actual layout of the diffusion plate 130. In some examples, the distance h from the plurality of light sources 120 to the diffusion plate 130 is a set distance, and a distance between adjacent light sources of the plurality is selected such that the ratio MH remains within a specified range (e.g., 1≦MH≦3).

In general, light uniformity is theoretically the most ideal when a numerical value thereof approximates 1. When light uniformity is 0.8 or more, it may be difficult to perceive abnormalities in light uniformity when visually perceived. Thus, a light uniformity of 0.8 or more may be acceptable, and the above-mentioned formula may be used to identify values of MH for which the light uniformity is equal to 0.8 or more. According to the present embodiment as described above, deterioration in light uniformity may be prevented while improving use efficiency of the light source substrate 110 and layout efficiency of the light sources 120 by selecting a value of MH that maintains light uniformity at or above 0.8. Hence, values of MH within the range of 1≦MH≦3 may be preferentially selected so as to maintain light uniformity at or above 0.8, according to the graph of FIG. 6. Values of MH below 1 may result in low light uniformity (i.e., a uniformity below 0.8), while values of MH in excess of 3 are associated with large distances between the plurality of light sources 120 and the diffusion plate 130 resulting in bulky lighting apparatuses.

Hereinafter, referring again to FIG. 1, another characteristic of the light emitting module 100 according to the embodiment will be described.

With reference to FIG. 1, the light source substrate 110 may include at least one hook part 118 and/or at least one through-hole 116 for screw fastening, to allow the light source substrate to be fastened to a base part when the light source substrate is used in a surface illumination apparatus, such as a backlight unit or the like. The light source substrate 110 may include both the hook part 118 and the through-hole 116 for screw fastening in order to increase compatibility in a fastening scheme and allow for a degree of design freedom. The through-hole 116 may be spaced apart from the hook part 118 as shown in FIG. 1, or the through-hole 116 may be located in the hook part 118.

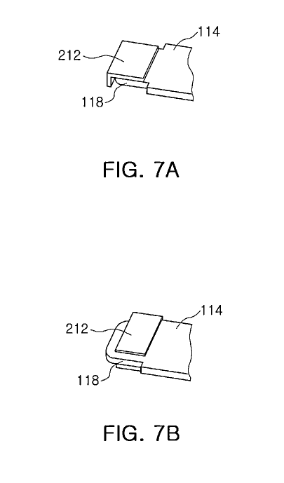

Here, the hook part 118 may be closely fastened to a hook 212 provided with a fastening target. The hook 212 may be provided in the base part and extend upwards from an upper surface of the base part. A front fastening scheme as shown in FIG. 7A or a side fastening scheme as shown in FIG. 7B may be applied thereto, but fastening schemes should not be construed as being limited thereto. Thus, various schemes for closely fastening the hook part 118 to the hook fixing frame 212 may be employed. While a single hook 212 is shown in FIGS. 7A and 7B, more commonly a plurality of hooks 212 are disposed on the surface of the base part and are configured to simultaneously engage a plurality of hook parts 118 formed in the light source substrate 110 to securely hold the light source substrate 110 in place on the base part.

As shown in FIGS. 7A and 7B, the hook part 118 is configured to engage with a hook 212 of the base part to securely fix the light emitting module to the base part. As shown in FIG. 1, the hook part 118 can be disposed at an end of a branch part 114 that is spaced away from the spine part 112. In addition, the embodiment with reference to FIG. 1 shows an example in which the hook part 118 is disposed on an edge portion of the branch part 114, but this should not be considered to be limiting. That is, the hook part 118 may be disposed on another surface of the light source substrate 110. For example, the hook part 118 may be disposed on one side of the spine part 112.

The light source substrate 110 may include at least one connector part 140 to transmit and receive power (e.g., as an external electrical signal) to drive the plurality of light sources 120.

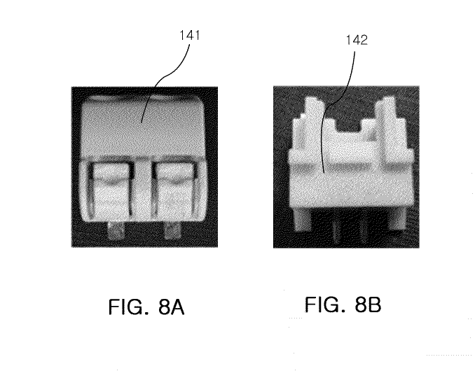

In detail, the connector part 140 may include at least one of a poke-in type connector 141 as shown in FIG. 8A and a push-in type connector as shown in FIG. 8B. In consideration of compatibility and design freedom, the poke-in type connector 141 and the push-in type connector 142 may both be included in a single light source substrate 110.

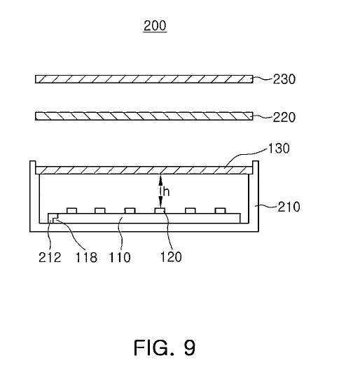

FIG. 9 is a schematic cross-sectional view of a surface illumination apparatus 200 according to an embodiment.

With reference to FIG. 9, the surface illumination apparatus 200 of an embodiment may include a base part 210 and a light emitting module safely mounted on the base part 210.

The light emitting module may include a light source substrate 110 including a spine part 112 and at least one branch part 114 extending laterally from a side surface of the spine part 112, and a plurality of light sources 120 disposed on the light source substrate 110. A diffusion plate 130 is disposed in a path of light emitted from the plurality of light sources 120. The plurality of light sources 120 may be arrayed in a pattern according to a repeated diamond shape pattern, with a respective light source 120 disposed at each vertex position of the diamond pattern while having no light source 120 disposed in the inside of the diamonds in the pattern.

Further, a length ratio of two intersecting diagonal lines of each diamond in the diamond shape pattern may be within the range of 1:1 through 1:1.5. Additionally, a layout of the plurality of light sources 120 and a distance between the light sources 120 and the diffusion plate 130 may satisfy the following numerical expression:

$$0.8 \leq - 0.0592 M {H}^{4} + 0.4979 M {H}^{3} - 1.5269 M {H}^{2} + 1.9902 M H - 0.0888 , \\ where$$

$$M H = \frac{\begin{matrix}Distance ( h ) between the plurality of \\ light sources and the diffusion plate\end{matrix}}{\begin{matrix}Greater length among lengths of two intersecting \\ diagonals ( x , y ) of diamond shape pattern\end{matrix}} .$$

That is, it can be considered that the surface illumination apparatus 200 according to the present embodiment may include the light emitting module 100 described according to the above-mentioned embodiment and the diffusion plate 130.

The surface illumination apparatus 200 may additionally include a light collecting sheet 220 disposed above the diffusion plate 130 and collecting light incident thereinto in a vertical direction, and may also further include a protective sheet 230 protecting an optical structure disposed below.

In the present embodiment, the base part 210 and the light source substrate 110 mounted on the base part 210 are fixed to each other by the hook 212 and the hook part 118 fastened to each other, but the inventive concepts are not limited thereto. That is, a screw fastening scheme using a through-hole 116, formed in the light source substrate 110, may be used. In addition, the hook fastening scheme may be applied to fix one side of the light source substrate 110 to the base part 210, and a screw fastening scheme may be applied to fix another side of the light source substrate 110 to the base part 210, so as to securely fix the base part 210 and the light source substrate 110 to each other.

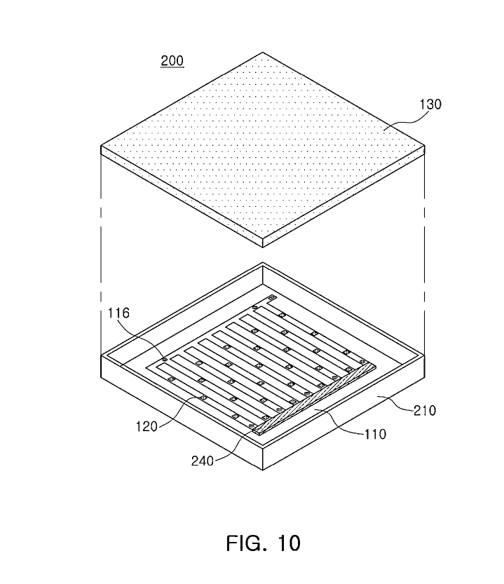

FIG. 10 is a perspective view of the surface illumination apparatus 200 according to another embodiment.

With reference to FIG. 10, the surface illumination apparatus 200 according to the embodiment may include a fixing bar 240 fixing a base part 210 and a light source substrate 110 to each other.

The fixing bar 240 may be disposed to cover a portion of the light source substrate 110 on which light sources 120 are not located. As shown in FIG. 10, the fixing bar 240 may be disposed to cover a portion of at least one branch part 114, such as an end portion of the at least one branch part 114 that is located distally from the spine part 112. The fixing bar 240 may additionally or alternatively be disposed to cover a portion of the spine part 112.

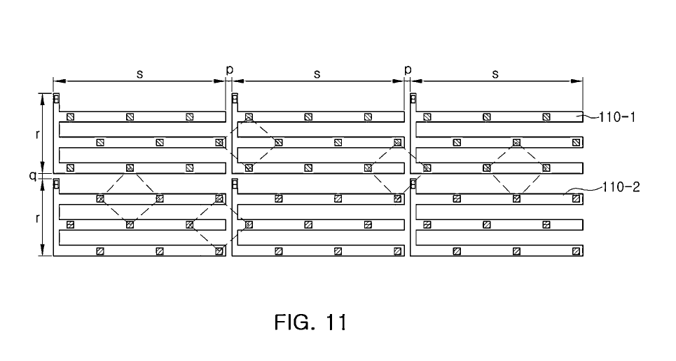

FIG. 11 is a schematic plan view of a surface illumination apparatus 200 according to another embodiment.

With reference to FIG. 11, the surface illumination apparatus 200 according to the embodiment may include a plurality of light source substrates 110-1 and 110-2 disposed to be adjacent to each other. The plurality of light source substrates 110-1 and 110-2 can be disposed such that light sources 120 disposed on edges of adjacent light source substrates satisfy the conditions for a regular repeated arrangement (e.g., a repetitive array condition, such as the repeated diamond shape pattern). The light sources 120 may further be disposed on each respective light source substrate 110-1 and 110-2 to as to satisfy the condition for the regular repeated arrangement. In particular, the light sources 120 within a light source substrate 110 and between adjacent light source substrates (110-1 and 110-2) may satisfy the regular repeated arrangement condition, as well as conditions relating to a length ratio of two intersecting diagonal lines of the diamond shape pattern and to a distance to a diffusion plate 130 discussed above.

More specifically, when the arrays of light sources 120 disposed on each one of the light source substrates 110-1 and 110-2 are respectively defined as matrix M1 and matrix M2, the location of light sources 120 can be represented as follows:

$$M 1 = ( \begin{matrix}1 & 0 & 1 & 0 & 1 & 0 \\ 0 & 1 & 0 & 1 & 0 & 1 \\ 1 & 0 & 1 & 0 & 1 & 0\end{matrix} ) , \\ M 2 = ( \begin{matrix}0 & 1 & 0 & 1 & 0 & 1 \\ 1 & 0 & 1 & 0 & 1 & 0 \\ 0 & 1 & 0 & 1 & 0 & 1\end{matrix} ) ,$$

where a ‘1’ indicates the presence of a light source and a ‘0’ indicates no light source within each array.

In a case in which the number of light sources 120 disposed in a first column is set to be different from the number of light sources 120 disposed in a last column of the matrix, when the plurality of respective light source substrates 110-1 and 110-2 are positioned adjacent to each other, the respective conditions described above (the arrangement of light sources, the length ratio of two intersecting diagonal lines within a diamond shape pattern, and the layout relational numerical expression with regard to a distance to the diffusion plate) may also be satisfied between the mutual light source substrates 110-1 and 110-2.

That is, the plurality of light source substrates 110-1 and 110-2 mounted on the base part 210 may be disposed according to a matrix

$$T = ( \begin{matrix}M 1 & M 1 & M 1 \\ M 2 & M 2 & M 2\end{matrix} ) ,$$

and all of the plurality of light sources 120 disposed in the matrix T may satisfy the conditions on the array of light sources satisfied on the respective light source substrates 110-1 and 110-2 (namely, the repetitive arrangement in a diamond shape pattern, the length ratio of two intersecting diagonal lines within the diamond shape, and the layout relational numerical expression with regard to the distance to diffusion plate). Furthermore, the spacing between and alignment of adjacent light source substrates 110-1 and 110-2 can be set so as to respect each of the conditions.

When a plurality of light source substrates 110-1 and 110-2 are provided, heat emission may be improved as compared with a case in which a single relatively large light source substrate is used, and the light source substrates may be protected from damage due to impacts or the like.

In addition, when the plurality of light source substrates 110-1 and 110-2 are used according to the present embodiment, a total substrate area (e.g., a total surface area of the light source substrates 110-1 and 110-2) is 3rs. In comparison, when a single relatively large light source substrate is used to mount all of the light sources, a total substrate area of

$$\frac{( 2 r + q ) \cdot ( 3 s + 2 p )}{2}$$

is needed. The use of multiple individual light source substrates 110-1 and 110-2 thus effectively reduces the total needed substrate area.

As set forth above, according to an embodiment of the present inventive concepts, a light emitting module having improved component efficiency and lighting uniformity through a design and a layout of a light source substrate and of light sources is provided.

According to another embodiment, a surface illumination apparatus including the light emitting module disposed therein, as described above, is provided.

While the inventive concepts have been shown and described in connection with particular illustrative embodiments, it will be apparent to those skilled in the art that modifications and variations can be made without departing from the spirit and scope of the present inventive concepts as defined by the appended claims.

What is claimed is:

1. A lighting device comprising:
a light emitting module comprising:
a light source substrate including a spine part and at least one branch part extending from a side surface of the spine part; and
a plurality of light sources disposed on the light source substrate and arranged in a repeated diamond shape pattern in which a light source is disposed at each vertex of each diamond and no light source is disposed in an interior of a diamond; and
a diffusion plate disposed in a path of light emitted from the plurality of light sources,
wherein a length ratio of two intersecting diagonals of each diamond in the diamond shape pattern is at least 1:1 and no more than 1:1.5, and
a distance h between the plurality of light sources and the diffusion plate satisfies the following numerical expression:
$$0.8 \leq - 0.0592 M {H}^{4} + 0.4979 M {H}^{3} - 1.5269 M {H}^{2} + 1.9902 M H - 0.0888 , \\ where$$
$$M H = \frac{\begin{matrix}Distance ( h ) between the plurality of \\ light sources and the diffusion plate\end{matrix}}{\begin{matrix}Greater length among lengths of two intersecting \\ diagonals ( x , y ) of diamond shape pattern\end{matrix}} .$$

2. The lighting device of claim 1, wherein the MH value satisfies the condition of 0.01≦MH≦3.

3. The lighting device of claim 1, wherein the plurality of light sources arranged in the repeated diamond shape pattern are disposed in a plurality of columns, and a difference between a number of light sources disposed in a left-most column of the plurality of columns and a number of light sources disposed in a right-most column of the plurality of columns is 1.

4. The light emitting module of claim 1, wherein the spine part is rectangular.

5. The light emitting module of claim 1, wherein the light source substrate comprises a plurality of branch parts and the plurality of light sources are mounted on the plurality of branch parts.

6. The light emitting module of claim 1, wherein the light source substrate comprises a plurality of branch parts, and
at least one of the plurality of branch parts extends from one side surface of the spine part and at least another of the plurality of branch parts extends from another side surface of the spine part opposite to the one side surface.

7. The light emitting module of claim 1, wherein the branch part further includes at least one sub-branch portion extending from a side surface of the branch part.

8. The light emitting module of claim 1, further comprising:
a hook part disposed on one side portion of the light source substrate.

9. The light emitting module of claim 1, further comprising:
a through-hole for screw fastening, disposed on the light source substrate.

10. The light emitting module of claim. 1, further comprising:
a connector part disposed on the light source substrate, the connector part including both of a poke-in type connector and a push-in type connector.

11. The light emitting module of claim 1, wherein the light source substrate is a printed circuit board (PCB) having a circuit pattern disposed thereon.

12. A surface illumination apparatus comprising:
a base part;
a light emitting module mounted on the base part,
the light emitting module comprising:
a light source substrate including a spine part and at least one branch part extending from a side surface of the spine part; and
a plurality of light sources disposed on the light source substrate and arranged in a repeated diamond shape pattern in which a light source is disposed at each vertex of each diamond and no light source is disposed in an interior of a diamond; and
a diffusion plate disposed in a path of light emitted from the plurality of light sources,
wherein a ratio of lengths of two intersecting diagonals of each diamond in the diamond shape pattern is at least 1:1 and no more than 1:1.5, and
a distance h between the plurality of light sources and the diffusion plate satisfies the following numerical expression:
$$0.8 \leq - 0.0592 M {H}^{4} + 0.4979 M {H}^{3} - 1.5269 M {H}^{2} + 1.9902 M H - 0.0888 , \\ where$$
$$M H = \frac{\begin{matrix}Distance ( h ) between the plurality of \\ light sources and the diffusion plate\end{matrix}}{\begin{matrix}Greater length among lengths of two intersecting \\ diagonals ( x , y ) of diamond shape pattern\end{matrix}} .$$

13. The surface illumination apparatus of claim 12, wherein the base part further includes a fixing bar covering a portion of the branch part and fixing the light emitting module to the base part.

14. The surface illumination apparatus of claim 12, wherein the light source substrate further includes a hook part disposed on one side thereof, and the light emitting module is fastened to the base part by the hook part and a hook formed on the base part.

15. The surface illumination apparatus of claim 12, wherein the light source substrate comprises a plurality of light source substrates having the plurality of light sources disposed thereon, and the plurality of light source substrates are disposed on the base part to be adjacent to one another such that light sources disposed on different light source substrates that are adjacent to one another are disposed so as to be arranged according to the repeated diamond shape pattern and to satisfy the ratio of lengths of two intersecting diagonals of each diamond in the diamond shape pattern and to satisfy the numerical expression for the distance h between the plurality of light sources and the diffusion plate.

16. A lighting device comprising:
a light emitting module comprising:
a light source substrate including a spine part and at least one branch part extending from a side surface of the spine part; and
a plurality of light sources disposed on the light source substrate and arranged in a repeated diamond shape pattern in which a light source is disposed at each vertex of each diamond and no light source is disposed in an interior of a diamond; and
a diffusion plate disposed in a path of light emitted from the plurality of light sources,
wherein a distance h between the plurality of light sources and the diffusion plate satisfies the following numerical expression:
1≦MH≦3,
where MH is a ratio of the distance h to the greater of two diagonal lengths of diamonds in the diamond shape pattern.

17. The lighting device of claim 16, wherein a ratio of lengths of the two diagonals of each diamond in the diamond shape pattern is at least 1:1 and no more than 1:1.5.

18. The lighting device of claim 16, wherein the light source substrate comprises first and second separated light source substrates having interlocking shapes, such that the first and second separated light source substrates jointly form a substantially rectangular substrate when positioned so as to be interlocked.

19. The lighting device of claim 18, wherein the light source substrate comprises a plurality of branch parts extending from a side surface of the spine part, and a width of each branch part is substantially equal to a spacing between adjacent branch parts extending from the side surface of the spine part.
